(19) United States
(12) Patent Application Publication
(10) Pub. No.: US 2025/0029040 A1
(43) Pub. Date: Jan. 23, 2025

(54) INFORMATION ASSIGNING DEVICE, INFORMATION ASSIGNING METHOD, AND INFORMATION ASSIGNING PROGRAM

(71) Applicant: Nippon Telegraph and Telephone Corporation, Tokyo (JP)

(72) Inventors: Yuki Urabe, Musashino-shi, Tokyo (JP); Kimio TSUCHIKAWA, Musashino-shi, Tokyo (JP); Taisuke WAKASUGI, Musashino-shi, Tokyo (JP); Fumihiro YOKOSE, Musashino-shi, Tokyo (JP); Ryo UCHIDA, Musashino-shi, Tokyo (JP); Sayaka Yagi, Musashino-shi, Tokyo (JP)

(21) Appl. No.: 18/714,610

(22) PCT Filed: Dec. 8, 2021
(86) PCT No.: PCT/JP2021/045213

§ 371 Date: May 30, 2024

(51) Int. Cl. G06Q 10/0633

(52) U.S. Cl. CPC G06Q 10/0633

(57) ABSTRACT

An information imparting device identifies operations corresponding to events indicated in an operation log of a computer. The information imparting device creates a work model that is information in which a pattern of a combination and a sequential order of identified operations identified is associated with work in business. The information imparting device imparts work information that is information indicating corresponding kinds of work to respective events indicated in the operation log by using the work model. The information imparting device imparts, based on a captured image of a screen of the computer, case information that is information indicating corresponding cases to the respective events to which the work information has been imparted, of the events indicated in the operation log.

### TECHNICAL FIELD

The present invention relates to an information imparting device, a method for imparting information, and an information imparting program.

### BACKGROUND ART

In order to realize effective business improvement in a company or the like, it is important to accurately understand target business. A person in charge of business performs a plurality of kinds of business daily using an information terminal such as a personal computer (PC) or a tablet terminal. In addition, the business performed through the information terminal includes a plurality of kinds of work.

For example, work performed by the PC indicates, for example, a series of information input operations (input into a text box, clicking of a button, and the like) necessary for carrying out business.

Operation procedures in actual business are diversified due to various factors such as a person in charge and details of orders. An operation procedure is basically defined in a manual. However, since work details change from the beginning of creation of a manual or a person in charge performs work by a unique method, a divergence between the manual and an operation procedure in actual business may occur.

A business analyst needs to understand how much time is taken for what kind of work and what kind of procedure is performed for the work as a precondition for business improvement measure consideration.

For example, when robotic process automation (RPA) is introduced in order to enhance a business improvement effect, efficient business improvement can be realized by understanding a type and amount of work performed in the business and introducing the RPA from a work type with a heavy workload.

In the related art, a technology for analyzing and visualizing a flow of work performed in business using process mining in order to identify a business improvement point is known (for example, Non Patent Literature 1).

Information used in the analysis and visualization of process mining is an operation log in which an event to be analyzed is recorded. In addition, in the process mining, the operation log is divided into a group of work. For example, the operation log includes an operation time point, an event, case information (also referred to as a sequence), and the like.

In the process mining, it is possible to find a main flow by superimposing the same events of operation logs for each item of case information, which are the same work, and visualizing a process.

In addition, in the process mining, a plurality of cases are arranged and visualized so that the same operation is in the same column, and thus it is possible to compare events occurring for each case and find a problem.

The events to be analyzed vary depending on a type and size of business to be analyzed. For example, an event to be analyzed is an operation on a graphical user interface (GUI) component such as a button click or an input to a text box.

In addition, in the related art, a technology for comprehensively collecting operation logs related to operations performed on a PC is known (see, for example, Non Patent Literature 2).

### CITATION LIST

### Non Patent Literature

Non Patent Literature 1: Urabe, Yagi, Tsuchikawa, Masuda, Study of Business Process Visualization Method using Operation Log, IEICE Technical Report, vol. 118, no. 483, ICM2018-64, pp. 83-88, March, 2019
Non Patent Literature 2: Yokose, Urabe, Yagi, Tsuchikawa, Masuda, Oishi, DX suishin ni koken suru gyōmu kashika gijutsu (in Japanese) (Business visualization technology contributing to DX promotion), NTT Technical Journal, vol. 32, no. 2, February, 2020

### SUMMARY OF INVENTION

### Technical Problem

However, the related art has a problem in that it is difficult to efficiently perform process mining.

For example, in order to perform process mining by the method described in Non Patent Literature 1, it is necessary to specify an operation for each event indicated in an operation log and to clarify work and a case in business corresponding to each event.

On the other hand, operation logs collected by the method of Non Patent Literature 2 do not indicate operations, corresponding work, and cases of events.

On the other hand, although it is conceivable to manually impart necessary information to an operation log, efficiency decreases by such a method.

### Solution to Problem

In order to solve the above-described problems and achieve objects, there is provided an information imparting device including: an identification unit that identifies operations corresponding to events indicated in an operation log of a computer; a creation unit that creates a work model that is information in which a pattern of a combination and a sequential order of operations identified by the identification unit is associated with work in business; a work information imparting unit that imparts first information that is information indicating corresponding kinds of work to respective events indicated in the operation log by using the work model; and a case information imparting unit that imparts, based on a captured image of a screen of the computer, second information that is information indicating corresponding cases to the respective events to which the first information has been imparted, of the events indicated in the operation log.

### Advantageous Effects of Invention

According to the present invention, process mining can be efficiently performed.

### BRIEF DESCRIPTION OF DRAWINGS

FIG. 1 is a diagram illustrating a configuration example of an information imparting system according to a first embodiment.

FIG. 2 is a diagram illustrating an example of a communication log.

FIG. 3 is a diagram illustrating an example of work model information.

FIG. 4 is a diagram illustrating an example of a work model creation screen.

FIG. 5 is a diagram for describing an information imparting procedure.

FIG. 6 is a diagram for describing an information imparting procedure.

FIG. 7 is a diagram illustrating an example of a screen on which work information is visualized.

FIG. 8 is a diagram illustrating an example of a screen on which case information is visualized.

FIG. 9 is a flowchart illustrating a flow of processing of the information imparting device according to the first embodiment.

FIG. 10 is a diagram illustrating an example of a computer that executes an information imparting program.

### DESCRIPTION OF EMBODIMENTS

Hereinafter, embodiments of an information imparting device, a method for imparting information, and an information imparting program according to the present application will be described in detail with reference to the drawings. Moreover, the present invention is not limited to the embodiments described below.

### First Embodiment

Here, an operation log is a set of records corresponding to respective events generated according to an operation on a computer.

A record includes a date and time when an event has occurred, information on an application to be operated, details of the operation, information on a screen and a GUI part displayed on the computer at the time of the operation, and the like.

Here, in the operation log used for process mining, it is necessary to assume that an operation and a case corresponding to each event are already known. In addition, in a case where process mining is performed for each work, it is necessary to assume that work performed for each event is already known.

On the other hand, in a technology described in Non Patent Literature 2, an operation, work, and a case corresponding to each event are not identified the collected operation logs.

For example, in a computer, operations corresponding to various cases and kinds of work are performed, whereas an operation log may be saved in one file regardless of the corresponding cases and work. In this case, in the technology of the related art, it is difficult to distinguish between cases and kinds of work corresponding to records in the file.

An information imparting device according to this embodiment identifies operations of events included in an operation log and further imparts information indicating work and a case corresponding to each event.

### Configuration of First Embodiment

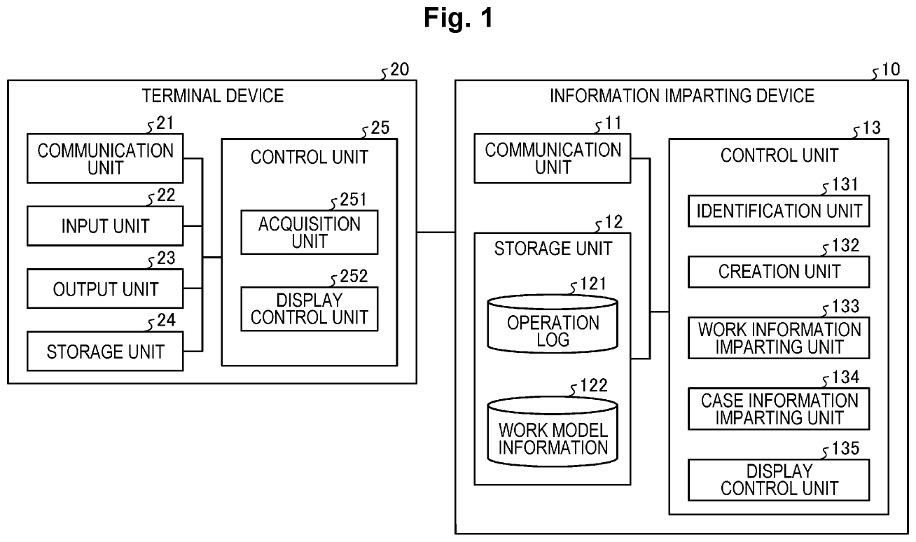

FIG. 1 is a diagram illustrating a configuration example of an information imparting system according to a first embodiment. As illustrated in FIG. 1, an information imparting system 1 includes an information imparting device 10 and a terminal device 20.

For example, the information imparting device 10 is a server. In addition, for example, the terminal device 20 is a computer such as a personal computer, a smartphone, or a tablet terminal.

It is assumed that the information imparting device 10 and the terminal device 20 are connected via a network so that data communication can be performed.

A user operates the terminal device 20 in business. For example, the terminal device 20 executes an application such as a web browser, spreadsheet software, or document creation software. Accordingly, the user performs an operation such as an input on a GUI part displayed on a screen by the terminal device 20.

Moreover, some or all of the functions of the information imparting device 10 may be provided in the terminal device 20. In that case, the terminal device 20 can function as an information imparting device.

As illustrated in FIG. 1, the information imparting device 10 includes a communication unit 11, a storage unit 12, and a control unit 13.

The communication unit 11 performs data communication with other devices via a network. For example, the communication unit 11 is a network interface card (NIC).

The storage unit 12 is a storage device such as a hard disk drive (HDD), a solid state drive (SSD), or an optical disc. Moreover, the storage unit 12 may be a data-rewritable semiconductor memory such as a random access memory (RAM), a flash memory, or a non-volatile static random access memory (NVSRAM).

The storage unit 12 stores an operating system (OS) or various programs executed by the information imparting device 10. The storage unit 12 stores an operation log 121 and work model information 122.

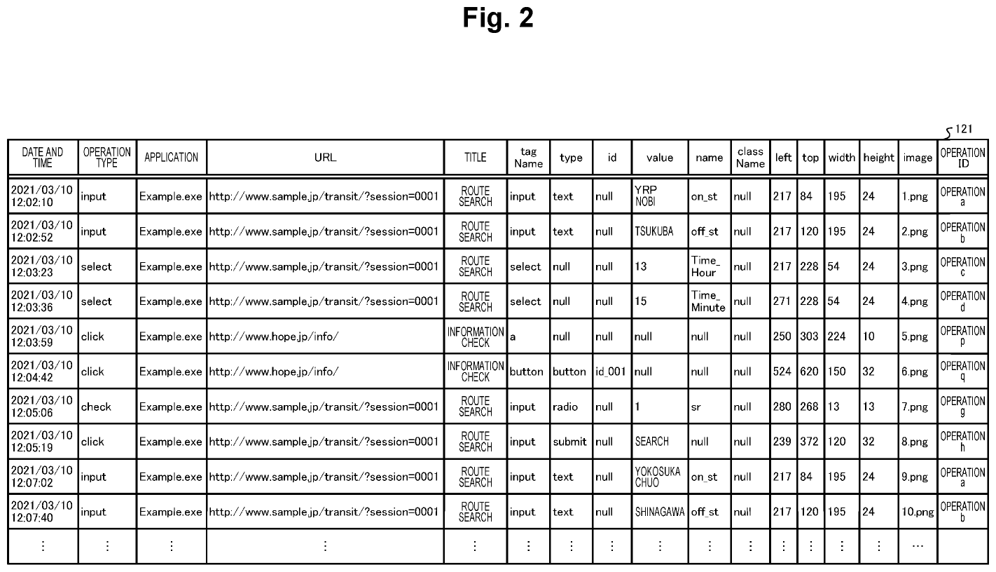

FIG. 2 is a diagram illustrating an example of the operation log. As illustrated in FIG. 2, the operation log 121 is a set of records corresponding to events generated according to the operations performed on the terminal device 20. Moreover, the terminal device 20 is an example of a computer.

Each column in the operation log 121 of FIG. 2 is referred to as an attribute. In addition, a value for each attribute of each record (row) in the operation log 121 is referred to as an attribute value.

In addition, the operation log 121 of FIG. 2 is assumed to be information regarding an operation on a web browser. The attributes of the operation log 121 are not limited to those illustrated in FIG. 2. The attributes of the operation log 121 may include, for example, history of inputs from an input device (a keyboard, a mouse, or the like), a character string of a command input on a character user interface (CUI), and the like.

The terminal device 20 executes a web browser to display a web page on a screen and receives an operation such as an input to a GUI part on the web page. The operation log 121 is information related to an operation on a web page.

Attributes included in the operation log 121 are as follows.
date and time: time point information (including date) at which event occurs
operation type: character string indicating type of operation
application: character string indicating name of executable file of application being executed
URL: character string indicating URL of displayed web page
title: character string indicating title of web page
tagName: character string indicating tag including GUI part
type: character string indicating type of GUI part
value: character string indicating input value to GUI part
id: character string for identifying GUI part
name: character string indicating name of GUI part
className: character string indicating name of class of GUI part
left: numerical value indicating position of GUI part
top: numerical value indicating position of GUI part
width: numerical value indicating position of GUI part
height: numerical value indicating position of GUI part
image: data of captured image of screen (for example, character string indicating file path)

Each attribute may correspond to a tag of HTML with the same name. In addition, a null value is set in the operation log 121 to a non-set attribute or an attribute for which an attribute value cannot be acquired.

Moreover, the attribute value included in the operation log 121 does not need to be information itself acquired from the terminal device 20. The attribute value may be obtained by processing acquired information, or may be obtained by combining a plurality of items of information. In addition, the plurality of items of combined information may not appear in the operation log 121.

Moreover, the attribute “operation ID” is information for identifying the operation of the event indicated in each record. A method of identifying the operation ID will be described below.

For example, a record in the first row of FIG. 2 indicates information regarding an event that occurred at “2021/03/10, 12:02:10” and occurred when the application “Example.exe” was displaying a web page with the URL “http://www.sample.jp/transit/?session=0001”.

In addition, the record in the first row of FIG. 2 indicates that a value of “YRP Noni” is input to a GUI part in which tagName is “input”, type is “text”, id is “null”, and name is “on_st” on a screen entitled “route search”.

In addition, the record in the first row of FIG. 2 indicates that the GUI part is located at a position represented by left “217”, top “84”, width “195”, and height “24”. In addition, it is illustrated that a captured image of a screen at the time of operation is stored in a file of “1.png”.

Moreover, the GUI part includes a text box, a button (including submitting button), a pull-down, a check box, a radio button, and the like.

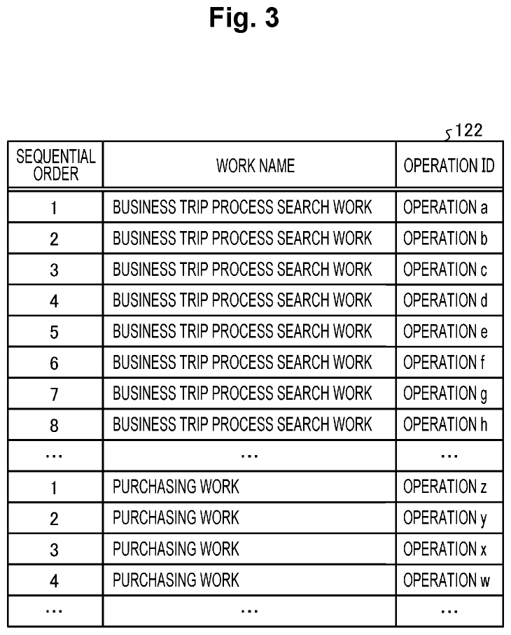

FIG. 3 is a diagram illustrating an example of the work model information. The work model information 122 stores a work model. As illustrated in FIG. 3, the work model is a pattern of a combination and a sequential order of operations. The operation is represented by an operation ID.

FIG. 3 illustrates that the work model having a work name of “business trip process search work” is a pattern in which operations are combined in a sequential order of an operation a, an operation b, an operation c, an operation d, an operation e, an operation f, an operation g, and an operation h.

Moreover, the work model may be identified by a work name as illustrated in FIG. 3, or may be identified by an ID imparted to each work model.

Returning back to FIG. 1, the control unit 13 controls the entire information imparting device 10. The control unit 13 is, for example, an electronic circuit such as a central processing unit (CPU), a micro processing unit (MPU), or a graphics processing unit (GPU), or an integrated circuit such as an application specific integrated circuit (ASIC) or a field programmable gate array (FPGA).

In addition, the control unit 13 includes an internal memory for storing programs or control data defining various processing procedures, and executes processes by using an internal memory. In addition, the control unit 13 functions as various processing units by operating various programs.

For example, the control unit 13 includes an identification unit 131, a creation unit 132, a work information imparting unit 133, a case information imparting unit 134, and a display control unit 135.

The identification unit 131 identifies an operation corresponding to an event indicated in the operation log 121 of the computer.

The identification unit 131 identifies an operation ID on the basis of attribute values of the operation log 121. The operation ID is an ID for identifying an event (record) corresponding to the same operation.

That is, in the terminal device 20, different events may occur even by the same operation. Conversely, different events may be considered to occur by the same operation.

For example, an event in which a character string of “abc” is input in a certain text box and an event in which a character string of “xyz” is input in the text box are both caused by an operation of “inputting a character string in a text box”. On the other hand, since the input character strings are different, the events are regarded as different events.

The identification unit 131 identifies an event of the same operation by applying any one of the following rules to each attribute of the operation log 121: (1) determination of a character string based on an exact match, (2) determination of a character string based on a partial match, (3) determination based on a range of numerical values, and (4) non-use for determination.

The identification unit 131 applies (1) to the operation type, the application, the tagName, the type, the id, and the name of the attributes of the operation log 121. The identification unit 131 applies (2) to the URL and the title of the attributes of the operation log 121. The identification unit 131 applies (3) to the width and the height of the attributes of the operation log 121. The identification unit 131 applies (4) to the date and time, the value, the className, the left, and the top of the attributes of the operation log 121.

For example, the identification unit 131 sets the operation ID of records of a first row and a ninth row of the operation log 121 illustrated in FIG. 2 to “operation a”. For example, in the records of the first row and the ninth row, the operation types and the applications match, but the dates and times and the values do not match.

The creation unit 132 creates a work model that is information in which a pattern of a combination and a sequential order of operations identified by the identification unit 131 is associated with work in business. The work model is a model indicating a series of operations performed to complete work in business.

The creation unit 132 may create the work model by designation of the user, the designation being received via a work model creation screen. For example, the creation unit 132 creates the work model on the basis of an operation associated with a captured image selected by the user, of captured images of screens of the computer, of the operations.

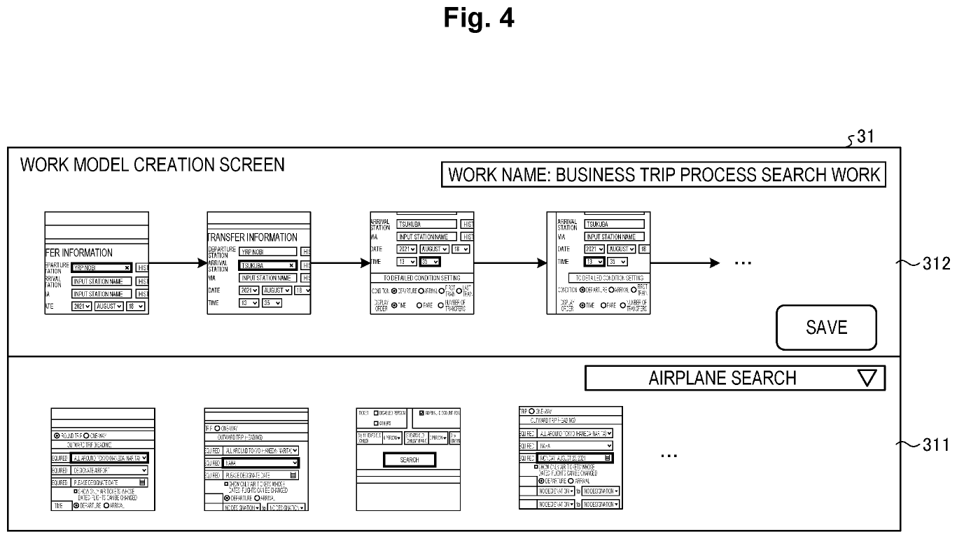

FIG. 4 is a diagram illustrating an example of the work model creation screen. For example, a work model creation screen 31 is created by the information imparting device 10 and is displayed by the terminal device 20. In addition, the work model creation screen 31 may be displayed by a device different from the terminal device 20.

The creation unit 132 extracts an operation ID of the operation log 121 and a capture image associated with the operation ID and displays a capture image for each operation ID in a region 311. Moreover, the creation unit 132 extracts the captured image with reference to the image of the operation log 121.

In addition, supplementary information regarding the captured image is displayed in the region 311. For example, the region 311 of FIG. 4 shows that the captured image is of an airplane search screen.

The creation unit 132 may display the captured image in the region 311 for each piece of information regarding the screen (Title, URL) so that the user can easily select the captured image.

In addition, the creation unit 132 may cut out only the periphery of the operation portion of the capture image to display the operation portion in an easy-to-understand manner, and may highlight a portion corresponding to the operation portion on the capture image by using information (top, left, width, height) of the operation portion (thick framed portion of the capture image in the region 311).

The user selects the captured image displayed in the region 311 and designates a sequential order. For example, the user moves the captured image selected in the region 311 to a region 312.

In the region 312, selected captured images are arranged and displayed at positions corresponding to the designated sequential order. In addition, a text box for inputting a work name is provided in the region 312. In the example of FIG. 4, “business trip process search work” is input as the work name.

The creation unit 132 stores the operation ID of operations corresponding to the captured images arranged in the region 312 and the sequential order based on the arranged positions in the work model information 122 in association with the input work name, for example, at the timing when a save button is pressed.

The work information imparting unit 133 imparts first information (work information) that is information indicating corresponding kinds of work to respective events indicated in the operation log 121 by using the work model.

For example, the work information imparting unit 133 imparts, as work information, information indicating the work included in the work model to consecutive events in a series in which the events indicated in the operation log 121 are arranged according to occurrence date and time, to the consecutive events satisfying a condition regarding a matching degree with a pattern included in the work model.

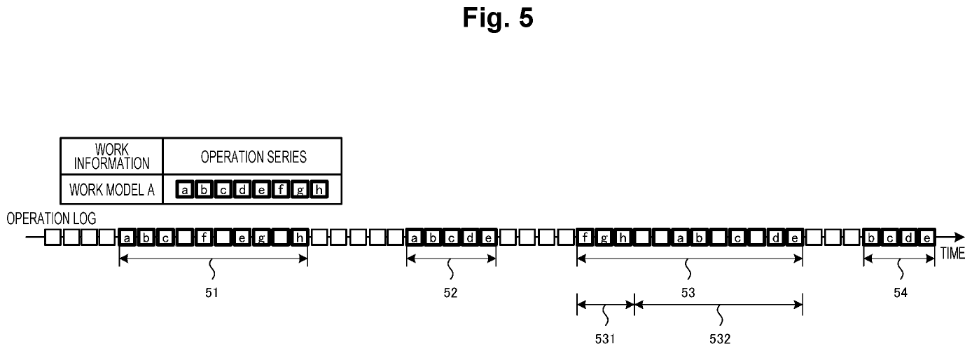

FIG. 5 is a diagram for describing an information imparting procedure. A series of FIG. 5 is obtained by arranging the events in the operation log 121 in order of occurrence date and time. A rectangular figure corresponds to each event, and an alphabet represents an operation ID. For example, in FIG. 5, the operation ID of “operation a” is written as “a” by omission.

In addition, a blank figure which is not filled in with the operation ID corresponds to an event in which the operation ID is not identified or an event in which the operation ID is irrelevant to a target work model.

The work information imparting unit 133 sequentially checks the series of events and identifies a range in which there is a possibility of matching with the work model. For example, the work information imparting unit 133 identifies consecutive events in which a series of the operation IDs (operation series) of the work model matches arrangement of the operation IDs.

For example, the work information imparting unit 133 detects, as a start point, an event having an operation ID of “a” from the series. Here, “a” is the first operation ID in the sequential order in a work model A.

Accordingly, the work information imparting unit 133 determines whether or not the operation ID of the event following the identified start point is included in the work model.

In addition, the work information imparting unit 133 may determine that an event having the title or the URL which matches those of the event determined to be included in the work model is also included in the work model, even though the operation ID is not included in the work model.

Accordingly, the work information imparting unit 133 sets an event immediately before an event determined not to be included in the work model as an end point.

Accordingly, the work information imparting unit 133 identifies a range from the start point to the end point. In the example of FIG. 5, the work information imparting unit 133 identifies a range 51, a range 52, a range 53, and a range 54 as ranges in which there is a possibility of matching with the work model A.

Next, the work information imparting unit 133 determines whether or not to impart the work information corresponding to the work model to the identified range. The work information imparting unit 133 makes a determination based on at least one of a matching degree of elements and a length of a series.

### (Matching Degree of Elements)

The work information imparting unit 133 checks each event in the identified range, adds 1 to a matching degree when an operation ID of an event matches the operation ID in the work model, and adds 0.5 to the matching degree when the operation ID of the event does not match the operation ID in the work model (corresponding to a blank figure).

### (Length of Series)

The work information imparting unit 133 calculates the number of matches between operation IDs of events in the identified range and the operation IDs of the work model as the length of the series.

For example, the work information imparting unit 133 calculates a matching degree as 9.0 and calculates the length of the series as 7 for the range 51.

The work information imparting unit 133 imparts work information to each event in a range in which at least one or both of the matching degree and the length of the series exceed a threshold value. For example, the threshold value of the length of the series may be a value such as 50% of the number of operation IDs of the work model.

For example, it is assumed that the matching degree and the length of the series in the range 51 exceed the threshold value, and the work name of the work model A is “business trip process search work”. In this case, the work information imparting unit 133 imparts “business trip process search work” to the attribute of “work name” added to the operation log 121 of the event included in the range 51.

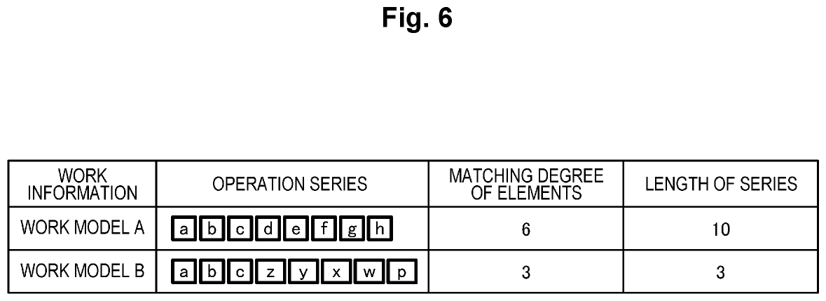

In addition, the range identified by the work information imparting unit 133 may correspond to a plurality of work models. For example, as illustrated in FIG. 6, a case where there is a possibility that the range 51 corresponds to both the work model A and the work model B will be considered. FIG. 6 is a diagram illustrating an information imparting procedure.

In this case, the work information imparting unit 133 determines which work model more corresponds to the identified range, based on the matching degree and the length of the series.

In the example of FIG. 6, since the work model A has larger values in both the matching degree and the length of the series, the work information imparting unit 133 determines that the work model A corresponds to the range 51.

In addition, the work information imparting unit 133 may determine the work model having a larger weighted sum of the matching degree and the length of the series as will be described below, as the work model corresponding to the identified range.

$$Weighted sum = matching degree \times 1 + length of series \times 2$$

The case information imparting unit 134 imparts, based on a captured image of a screen of the computer, second information (case information) that is information indicating corresponding cases to the respective events to which the work information has been imparted, of the events indicated in the operation log 121.

There is a possibility that the events in the range to which the work information has been imparted by the work information imparting unit 133 has occurred by repeatedly performing an operation related to one or more cases. Therefore, the case information imparting unit 134 further imparts the case information to the events in the range to which the work information has been imparted.

An example of a case where the case information imparting unit 134 further imparts the case information to the range to which the work information corresponding to the work model A has been imparted will be described.

The case information imparting unit 134 imparts the case information to two consecutive events in a series on a basis of a result of determining whether or not the two events correspond to the same case by comparing items of information of screens of the computer corresponding to the two respective consecutive events in a series in which the events to which the work information has been imparted, of the events indicated in the operation log 121, are arranged according to occurrence date and time.

First, the case information imparting unit 134 sets, as a start point of a case, an event having the operation ID which matches the first operation ID in the sequential order in the work model. For example, the first operation ID in the sequential order in the work model A is “a”.

The case information imparting unit 134 determines whether or not to impart the same case information as that of the first event to a second event of two consecutive events after the start point.

Here, it is assumed that work information is imparted to the range 51, the range 52, the range 53, and the range 54. In addition, the case information imparting unit 134 focuses only on the event to which the work information has been imparted. That is, an event that is consecutive to an event at the right end of the range 51 is considered to be an event at the left end of the range 52.

First, in a case where the screens of two consecutive events are the same, the case information imparting unit 134 imparts the same case information to the two consecutive events when all of the following conditions C1 to C4 are satisfied.

In addition, in a case where the screens of the two consecutive events are the same, the case information imparting unit 134 imparts the same case information to the two consecutive events when the following conditions C1 to C4 except for the condition C3 are satisfied.

Moreover, whether the screens are the same is determined depending on whether the titles of the operation log 121 are the same. In addition, in a case where the same case information is not imparted in accordance with the above procedure, the case information imparting unit 134 imparts case information different from that of the first event to the second event.

### (Condition C1)

An operation ID of the second event is not the first operation ID in the sequential order in the work model.

### (Condition C2)

Window handles of the screens of the two events match.

### (Condition C3)

A score of template matching for determining whether or not a captured image of an operation portion of a first event is included in a captured image of a screen of a second event is equal to or larger than a threshold value. However, the operation portion is acquired by the captured image of the screen and left, top, width, and height of the operation log 121.

### (Condition C4)

A difference between occurrence dates and times of the first event and the second event is equal to or less than a threshold value.

In addition, regardless of the above conditions, the case information imparting unit 134 sets an event in which the operation ID matches the operation ID of the last operation in the sequential order in the work model as an end point of the case. For example, the first operation ID in the sequential order in the work model A is “h”.

In the example of FIG. 5, the case information imparting unit 134 imparts the same case information (information indicating a case a) to the range 51, the range 52, and a range 531. On the other hand, the case information imparting unit 134 imparts the same case information (information indicating a case B) to a range 532 and the range 54.

Even in adjacent ranges to which the same work information has been imparted, such as the range 531 and the range 532, the case information may be different from each other.

The display control unit 135 displays a screen on which the work information imparted to the plurality of events indicated in the operation log 121 or both the work information and the case information are displayed. The display control unit 135 causes the terminal device 20 to display a screen on which the work information and the case information are visualized.

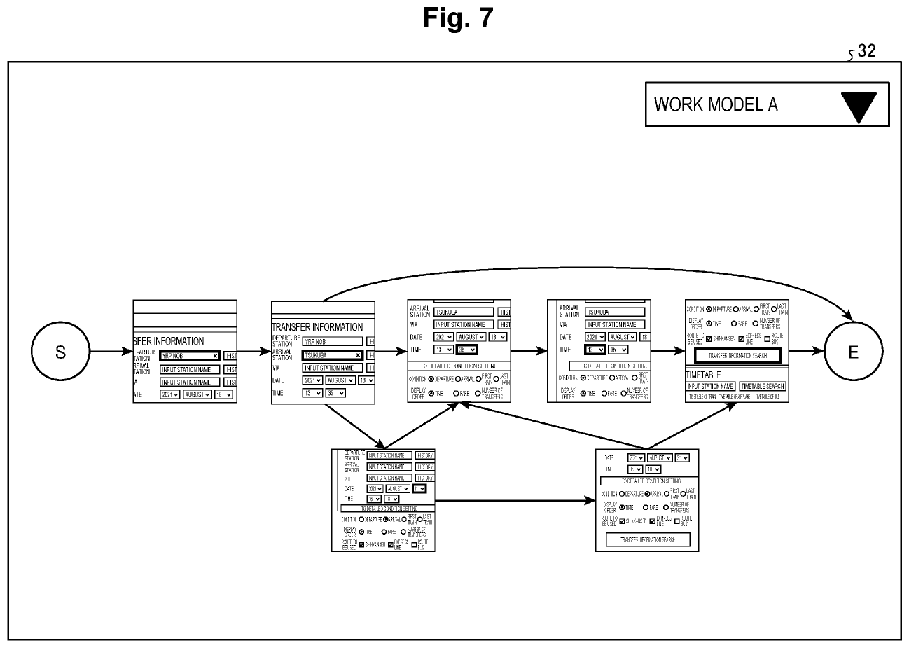

FIG. 7 is a diagram illustrating an example of the screen on which the work information is visualized. As illustrated in FIG. 7, the captured images of the events to which the work model A has been imparted are superimposed and displayed on a work information display screen 32 displayed by the display control unit 135. In addition, arrows between the captured images represent a sequential order of the operation IDs in the work model A.

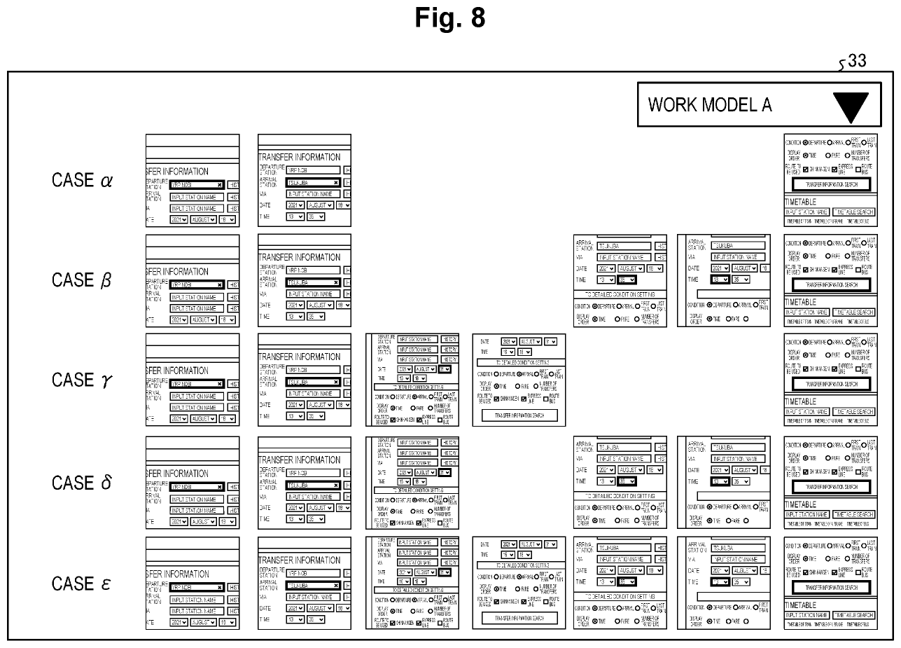

FIG. 8 is a diagram illustrating an example of a screen on which case information is visualized. As illustrated in FIG. 8, the captured image of the event to which the work model A has been imparted is displayed for each case on the case information display screen 33 displayed by the display control unit 135.

On the case information display screen 33, the captured images of the events with common cases are arranged in the same row, and the captured images of the events with common operation IDs are arranged in the same column.

Referring back to FIG. 1, the terminal device 20 includes a communication unit 21, an input unit 22, an output unit 23, a storage unit 24, and a control unit 25.

The communication unit 21 performs data communication with other devices via a network. For example, the communication unit 21 is the NIC.

The input unit 22 is an input device such as a keyboard and a mouse. In addition, the output unit 23 is a display device such as a display capable of outputting a screen.

The storage unit 24 is a storage device such as an HDD, an SSD, or an optical disc. Moreover, the storage unit 24 may be a data-rewritable semiconductor memory such as a RAM, a flash memory, or an NVSRAM.

The storage unit 24 stores an OS or various programs executed by the terminal device 20.

The control unit 25 controls the entire terminal device 20. The control unit 25 is, for example, an electronic circuit such as a CPU, an MPU, or a GPU or an integrated circuit such as an ASIC or an FPGA.

In addition, the control unit 25 includes an internal memory for storing programs or control data defining various processing procedures, and executes processing by using an internal memory. In addition, the control unit 25 functions as various processing units by operating various programs.

For example, the control unit 25 includes an acquisition unit 251 and a display control unit 252.

The acquisition unit 251 acquires an operation log in the terminal device 20. The acquisition unit 251 transmits the acquired operation log to the information imparting device 10.

The display control unit 252 causes the output unit 23 to display a screen. For example, the display control unit 252 displays the work model creation screen 31, the work information display screen 32, and the case information display screen 33 in response to control of the information imparting device 10.

### Processing of First Embodiment

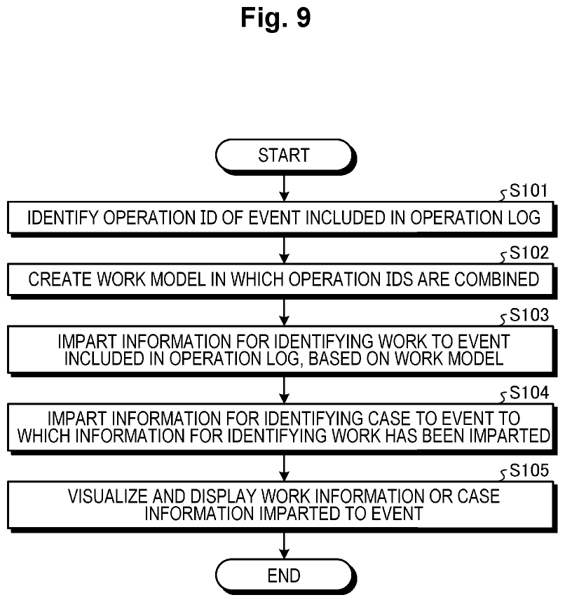

A flow of processing of the information imparting device 10 will be described with reference to FIG. 9. FIG. 9 is a flowchart illustrating a flow of processing of the information imparting device according to the first embodiment.

First, as illustrated in FIG. 9, the information imparting device 10 identifies an operation ID of an event included in an operation log (step S101). For example, even if the date and time and the input value are different from each other, the information imparting device 10 imparts the same operation ID to the event in which the names of the screen and the GUI part are common.

Next, the information imparting device 10 creates a work model in which the operation IDs are combined (step S102). For example, the information imparting device 10 provides the work model creation screen 31 to the user and creates the work model by combining the operation IDs of the events selected by the user.

Here, the information imparting device 10 imparts information for identifying work to an event included in the operation log on the basis of the work model (step S103). For example, the information imparting device 10 imparts the work information on the basis of the work model and a matching degree between a predetermined range in a series of events arranged according to the occurrence time point.

Subsequently, the information imparting device 10 imparts information for identifying a case to an event to which the information for identifying work has been imparted (step S104). For example, the information imparting device 10 imparts the case information based on a result of determining whether or not the two consecutive events in a series are of the same case.

Accordingly, the information imparting device 10 visualizes and displays the work information or the case information imparted to the event (step S105). For example, the information imparting device 10 causes the work information display screen 32 or the case information display screen 33 to be displayed.

### Effects of First Embodiment

As described above, the identification unit 131 identifies operations corresponding to events indicated in the operation log 121 of the computer. The creation unit 132 creates a work model that is information in which a pattern of a combination and a sequential order of operations identified by the identification unit 131 is associated with work in business. The work information imparting unit 133 imparts work information that is information indicating the corresponding work to the respective events indicated in the operation log 121 by using the work model. The case information imparting unit 134 imparts, based on the captured image of the screen of the computer, the case information that is information indicating the corresponding cases to the respective events to which the work information has been imparted, of the events indicated in the operation log 121.

In this manner, the information imparting device 10 automatically identifies the operation (operation ID) of each event of the operation log by using the work model and further imparts the work information and the case information. As a result, according to the embodiment, process mining can be efficiently performed.

Here, a method of manually checking the events in a technical operation log one by one and manually imparting the work information and the case information has a problem in that a large amount of operation is required.

In addition, since the work information and the case information are determined according to the flow of the operation, it is difficult to impart the work information and the case information without identifying the operation ID for each individual event indicated in the operation log.

In addition, the interpretation of attribute values of the operation log requires specialized knowledge about HTML and Document Object Model (DOM).

In addition, although it is conceivable to acquire operation logs to be divided for each case, it is not realistic for the user to start and end a log acquisition tool at the timing of the start and end of the case.

According to the present embodiment, the above problem can be solved.

In addition, the creation unit 132 creates the work model on the basis of an operation associated with a captured image selected by the user, of captured images of screens of the computer, of the operations.

Consequently, for example, even if the user does not have specialized knowledge and does not understand the details of the operation log, the work model can be created based on the captured image.

In addition, the user can create a work model in units of work recognized by the user. As a result, the user can understand the operation log for each work and each case by viewing the imparted work information and case information.

The work information imparting unit 133 imparts, as work information, information indicating the work included in the work model to consecutive events in a series in which the events indicated in the operation log 121 are arranged according to occurrence date and time, the consecutive events satisfying a condition regarding a matching degree with a pattern included in the work model. Consequently, the work information can be automatically imparted.

The case information imparting unit 134 imparts the case information to two consecutive events in a series on a basis of a result of determining whether or not the two events correspond to the same case by comparing items of information of screens of the computer corresponding to the two respective consecutive events in a series in which the events to which the work information has been imparted, of the events indicated in the operation log 121, are arranged according to occurrence date and time. Consequently, the case information can be automatically imparted.

The display control unit 135 displays a screen on which the work information imparted to the plurality of events indicated in the operation log 121 or both the work information and the case information are displayed. Consequently, the work information and the case information can be provided to the user in an easily understandable manner.

### [System Configuration and Others]

In addition, each component of each illustrated device is functionally conceptual, and does not necessarily need to be physically configured as illustrated. That is, a specific form of distribution and integration of the respective devices is not limited to the illustrated form, and all or some of the devices can be functionally or physically distributed or integrated in any unit, depending on various loads, usage conditions, and the like. Furthermore, all or an arbitrary part of each processing function performed in each device can be implemented by a central processing unit (CPU) and a program analyzed and executed by the CPU, or can be implemented as hardware by wired logic. Moreover, the program may be executed not only by a CPU but also by another processor such as a GPU.

In addition, of the items of processing described in the embodiment, all or some of the items of processing described as being automatically performed can be manually performed, or all or some of the items of processing described as being manually performed can be automatically performed by a known method. In addition, the processing procedures, the control procedures, the specific names, and the information including various kinds of data and parameters described in the above specification and drawings can be arbitrarily changed, unless otherwise specified.

### [Program]

As an embodiment, the information imparting device 10 can be implemented by installing, on a desired computer, an information imparting program for executing the information imparting processing described above as packaged software or online software. For example, by causing an information processing device to execute the information imparting program described above, it is possible to cause the information processing device to function as the information imparting device 10. The information processing device mentioned here includes a desktop or a laptop personal computer. In addition, the information processing device also includes a mobile communication terminal such as a smartphone, a mobile phone, and a personal handyphone system (PHS), a slate terminal such as a personal digital assistant (PDA), and the like.

In addition, in a case where the terminal device used by the user is implemented as a client, the information imparting device 10 can also be implemented as an information imparting server device that provides a service related to the information imparting processing described above to the client. For example, the information imparting server device is implemented as a server device that provides an information imparting service in which the operation log is input and the imparted work information and case information are output. In this case, the information imparting server device may be implemented as a web server or may be implemented as a cloud that provides a service related to the information imparting processing by outsourcing.

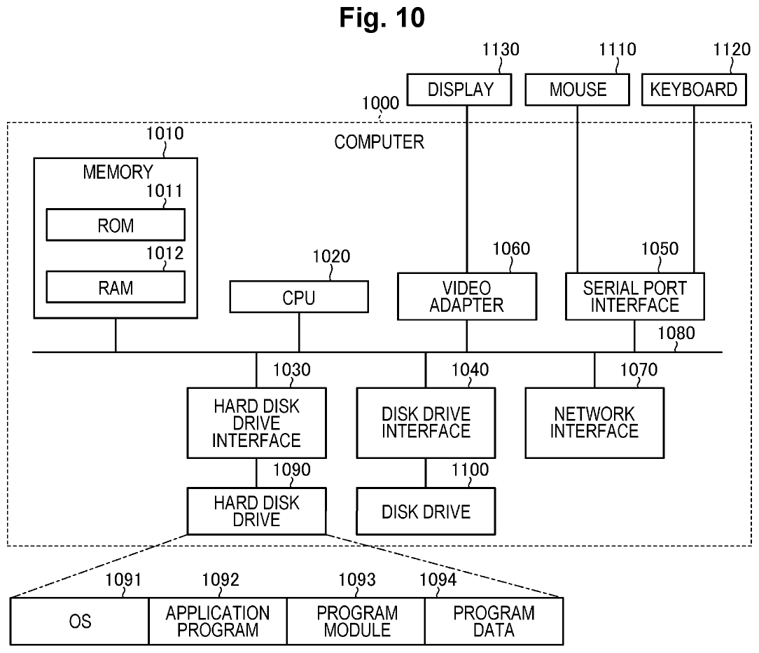

FIG. 10 is a diagram illustrating an example of the computer that executes the information imparting program. A computer 1000 includes a memory 1010 and a CPU 1020, for example. In addition, the computer 1000 also includes a hard disk drive interface 1030, a disk drive interface 1040, a serial port interface 1050, a video adapter 1060, and a network interface 1070. Those units are connected via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to a mouse 1110 and a keyboard 1120, for example. The video adapter 1060 is connected to a display 1130, for example.

The hard disk drive 1090 stores an OS 1091, an application program 1092, a program module 1093, and program data 1094, for example. That is, the program that defines each piece of processing performed by the information imparting device 10 is implemented as the program module 1093 in which codes executable by a computer are described. The program module 1093 is stored in, for example, the hard disk drive 1090. For example, the program module 1093 for executing processing similar to the functional configuration in the information imparting device 10 is stored in the hard disk drive 1090. Moreover, the hard disk drive 1090 may be replaced with a solid state drive (SSD).

In addition, setting data used in the processing of the above-described embodiment is stored, for example, in the memory 1010 or the hard disk drive 1090 as the program data 1094. Accordingly, the CPU 1020 reads the program module 1093 and the program data 1094 stored in the memory 1010 and the hard disk drive 1090 to the RAM 1012 as necessary, and executes the processing of the above-described embodiment.

Moreover, the program module 1093 and the program data 1094 are not limited to being stored in the hard disk drive 1090 and may be stored in, for example, a removable storage medium and be read by the CPU 1020 via the disk drive 1100 or the like. Alternatively, the program module 1093 and the program data 1094 may be stored in another computer connected via a network (a local area network (LAN), a wide area network (WAN), or the like). Accordingly, the program module 1093 and the program data 1094 may be read by the CPU 1020 from another computer via the network interface 1070.

### REFERENCE SIGNS LIST

1 Information imparting system
10 Information imparting device
11, 21 Communication unit
12, 24 Storage unit
13, 25 Control unit
20 Terminal device
22 Input unit
23 Output unit
31 Work model creation screen
32 Work information display screen
33 Case information display screen
121 Operation log
122 Work model information
131 Identification unit
132 Creation unit
133 Work information imparting unit
134 Case information imparting unit
135, 252 Display control unit
251 Acquisition unit

1. An information imparting device comprising:
an identification unit, comprising one or more processors, configured to identify operations corresponding to events indicated in an operation log of a computer;
a creation unit, comprising one or more processors, configured to create a work model that is information in which a pattern of a combination and a sequential order of operations identified by the identification unit is associated with work in business;
a work information imparting unit, comprising one or more processors, configured to impart first information that is information indicating corresponding kinds of work to respective events indicated in the operation log by using the work model; and
a case information imparting unit, comprising one or more processors, configured to impart, based on a captured image of a screen of the computer, second information that is information indicating corresponding cases to the respective events to which the first information has been imparted, of the events indicated in the operation log.

2. The information imparting device according to claim 1, wherein the creation unit is configured to create the work model on a basis of an operation associated with a captured image selected by a user of captured images of the screen of the computer, of the operations.

3. The information imparting device according to claim 1, wherein the work information imparting unit is configured to impart, as the first information, information indicating the work included in the work model to consecutive events in a series in which the events indicated in the operation log are arranged according to occurrence date and time, the consecutive events satisfying a condition regarding a matching degree with a pattern included in the work model.

4. The information imparting device according to claim 1, wherein the case information imparting unit is configured to impart the second information to two events on a basis of a result of determining whether or not the two events correspond to the same case by comparing items of information of screens of the computer corresponding to the two respective consecutive events in a series in which the events to which the first information has been imparted, of the events indicated in the operation log, are arranged according to occurrence date and time.

5. The information imparting device according to claim 1, further comprising a display control unit configured to display a screen on which the first information imparted for a plurality of events indicated in the operation log or both the first information and the second information are displayed.

6. A method for imparting information executed by an information imparting device, the method comprising:
identifying operations corresponding to events indicated in an operation log of a computer;
creating a work model that is information in which a pattern of a combination and a sequential order of operations identified in the identifying step is associated with work in business;
imparting first information that is information indicating corresponding kinds of work to respective events indicated in the operation log by using the work model; and
imparting, based on a captured image of a screen of the computer, second information that is information indicating a corresponding case to the respective events to which the first information has been imparted, of the events indicated in the operation log.

7. A non-transitory computer readable medium storing a program, wherein execution of the program causes a computer to function as an information imparting device according to claim 1.
